(19) United States
(12) Patent Application Publication
(10) Pub. No.: US 2007/0139808 A1
(43) Pub. Date: Jun. 21, 2007

(54) Information storage apparatus and storage medium

(75) Inventor: Nobuhide Aoyama, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/372,730

(22) Filed: Mar. 10, 2006

(30) Foreign Application Priority Data
Dec. 21, 2005 (JP) 2005-367902

(51) Int. Cl. G11B 19/02

(52) U.S. Cl. 360/69

(57) ABSTRACT

The present invention relates to an information storage apparatus that stores information in a storage medium, through the perpendicular magnetic recording system, and provides an information storage apparatus and a storage medium that can maintain the stability of recording and reproducing. The information storage apparatus includes a detection section that detects an alignment condition of magnetizations at each of portions on a storage medium and an alignment-condition recording section that records in the storage medium the alignment condition that has been detected by the detection section.

### BACKGROUND OF THE INVENTION

1. Field of the Invention

The present invention relates to an information storage apparatus and a storage medium that magnetically store information.

2. Description of the Related Art

Because, in the case of information recording through the perpendicular magnetic recording system, the transition width in a magnetization transition portion is smaller than that in the case of the longitudinal recording system, the perpendicular magnetic recording system has to date been drawing attention as a high-density recording technique, and information storage apparatuses that adopt the perpendicular magnetic recording system, storage media suitable for the perpendicular magnetic recording system, and the like have been proposed.

In a storage medium including information stored through perpendicular magnetic recording system, magnetizations are formed in a direction perpendicular to the surface of the storage medium; therefore, demagnetizing fields due to the magnetizations appear on the surface of the storage medium, whereby, because of the effect of the demagnetizing fields, fluctuation in the level of a signal to be detected by a reproducing head or in the sensitivity of magnetization formation to a recording current during recording may occur.

FIG. 12 is a schematic view illustrating a demagnetizing field.

When magnetization 2 is formed in a direction perpendicular to the surface of a recording medium 1, a demagnetizing field 3 occurs across one magnetization and another magnetization that are in opposite directions.

FIG. 13 is a view illustrating an example of the effect of a demagnetizing field.

In FIG. 13, the abscissa of a graph denotes a recording magnetic field, and the ordinate denotes magnetization on a storage medium. Additionally, the graph represents a so-called hysteresis curve in the case where magnetization is reversed through the recording magnetic field.

In the case where no demagnetizing field exists, the hysteresis curve is represented by thick dotted lines, and when a recording magnetic field having a predetermined magnetic-field intensity Hc is applied to the storage medium, the magnetization is reversed. In contrast, in the case where a demagnetizing field exists, the hysteresis curve is represented by solid lines, and unless a recording magnetic field having a magnetic-field intensity Hc′ higher than the magnetic-field intensity Hc is applied, the magnetization is not reversed. In other words, the fact suggests that, because the existence of the demagnetizing field deteriorates the sensitivity of magnetization formation, information cannot be recorded as long as a larger recording current is not applied.

For suppressing the effect of the demagnetizing field, there have been proposed a technique (refer to Japanese Patent Publication Laid-Open No. 1996-17004) in which, in the case where a recording signal that continuously forms magnetization having the same direction occurs, demagnetizing fields are reduced by inserting in the recording signal a short pulse signal that reverses the magnetization, a technique (refer to Japanese Patent Publication Laid-Open No. 1998-320705 and Japanese Patent Application Laid-Open No. 2002-230734) in which, by forming, between tracks in which magnetizations corresponding to information are formed, a random magnetization condition or a magnetization condition having a direction opposite to that of a magnetization condition in a track, demagnetizing fields are reduced, a technique (refer to Japanese Patent Application Laid-Open No. 2005-4917) in which, with regard to a servo pattern that, as marks for positions on a storage medium, is formed through magnetization on the storage medium, by making the entire magnetization amount zero, especially in a burst section of the servo pattern, demagnetizing fields from the servo pattern are reduced, and the like.

In addition, Japanese Patent Application Laid-Open No. 2004-93280, although being not a technique for coping with demagnetizing fields, discloses a technique in which a magnetization condition on a storage medium is measured through the Kerr effect, by irradiating light onto the storage medium.

However, the techniques disclosed in foregoing Japanese Patent Publication Laid-Open No. 1996-17004, Japanese Patent Publication Laid-Open No. 1998-320705, and Japanese Patent Application Laid-Open No. 2002-230734 reduce, but not eliminate demagnetizing fields, and the technique disclosed in foregoing Japanese Patent Application Laid-Open No. 2005-4917 is effective only for demagnetizing fields due to the burst section of a servo pattern, i.e., a special part; therefore, for example, in the case where, as a result of a user's utilization of an information storage apparatus or a storage medium, magnetizations having the same direction are aligned in a relatively wide area on a storage medium, demagnetizing fields due to a group of the aligned magnetizations are caused.

FIG. 14 is a schematic view illustrating a storage medium in which magnetizations are in a non-alignment condition; FIG. 15 is a schematic view illustrating a storage medium in which an alignment region is caused.

In a storage medium 1 illustrated in FIGS. 14 and 15, recording marks 4 have magnetization having a specific direction, and the portion other than the recording marks 4 has magnetization having a direction opposite to that of the magnetization on the recording marks 4; a track 5 is formed of a series of the recording marks 4. Paying attention to a region 6 having a relatively wide area on a recording medium 1, because, in FIG. 14, the directions of magnetizations are not unified, whereby the entire magnetization amount is approximately zero, a demagnetizing field does not exist that affects reading and writing of the recording marks 4 on the track 5. However, in FIG. 15, the region 6 to which attention is paid is an alignment region in which the concentration ratio of the recording marks 4 is high and magnetizations are aligned in the specific direction; therefore, if being accumulated, the entire region 6 causes a demagnetizing field, whereby reading and writing of the recording marks 4 on the track 5 is affected.

As discussed above, the techniques disclosed in foregoing Japanese Patent Publication Laid-Open No. 1996-17004, Japanese Patent Publication Laid-Open No. 1998-320705, Japanese Patent Application Laid-Open No. 2002-230734, and Japanese Patent Application Laid-Open No. 2005-4917 cannot avoid the effect of demagnetizing fields caused as a result of a user's utilization, whereby it has been a problem that the stability of recording and reproducing cannot be maintained.

### SUMMARY OF THE INVENTION

The present invention has been made in view of the above circumstances and provides an information storage apparatus and a storage medium that can maintain the stability of recording and reproducing.

An information storage apparatus according to the present invention, that, through the perpendicular magnetic recording system, stores information in a storage medium includes a detection section that detects an alignment condition of magnetizations at each of portions on the storage medium and an alignment-condition recording section that records in the storage medium the alignment condition that has been detected by the detection section.

Moreover, an information storage apparatus according to the present invention typically includes an information recording section that records information in the storage medium, in a manner in accordance with the alignment condition.

In an information storage apparatus according to the present invention, an alignment condition of magnetizations in a storage medium is detected and recorded; therefore, the stability of recording and reproducing can be maintained, based on the alignment conditions recorded as described above. During recording in particular, unlike during reproducing, it is difficult to obtain information as to the magnetization condition of a region in which information is to be recorded; therefore, it is useful in particular to refer to recorded alignment conditions.

Still moreover, in an information storage apparatus according to the present invention, it is optimal that an information recording section is included that records information in the storage medium and, in the case where recording ends up with failure, records the information again, in a manner in accordance with the alignment condition.

With the optimal information storage apparatus, information can efficiently be recorded, largely reducing chances of failure in information recording.

Furthermore, in an information storage apparatus according to the present invention, preferably the detection section detects an alignment condition of magnetization at each of representative points on the storage medium, and the magnetic effect on each representative point, from a far portion on the storage medium that is away from the representative point further than the other representative points, is 10% of or less than the magnetic effect from a vicinal portion on the storage medium excluding the far portion.

The shorter the space between the respective representative points is, the stronger becomes the magnetic effect on each representative point, from a portion that is away from the representative point, further than the other representative points; therefore, if an alignment condition is detected at a representative point at which the foregoing condition is satisfied, it can be considered that the magnetic effect between the respective representative points is approximately the same as the magnetic effect that affects the adjacent representative point. In other words, as long as the foregoing condition is satisfied, the space between the respective representative points can be widened, whereby labor hour or the like for the detection can be reduced.

Moreover, it is preferable that an information storage apparatus according to the present invention is configured in such a way that a magnetic head is included that records and reproduces information in the storage medium, and the detection section detects an alignment condition at each position, by, through the magnetic head, scanning the storage medium, in a two-dimensional fashion.

In the information storage apparatus according to the preferred embodiment, because a magnetic head utilized for recording and reproducing detects an alignment condition of magnetizations, alignment conditions that affect recording and reproducing can accurately be detected.

A storage medium, according to the present invention, in which, through the perpendicular magnetic recording system, information is stored, includes an information storage region in which the information is stored and an alignment-condition storage section in which an alignment condition of magnetizations at each of portions in the information storage region is stored.

With a storage medium according to the present invention, by implementing recording and reproducing based on alignment conditions stored in the alignment-condition storage section, information can stably be recorded and reproduced.

As described heretofore, according to the invention, the stability of recording and reproducing can be maintained.

### BRIEF DESCRIPTION OF THE DRAWINGS

FIG. 1 is a view illustrating an embodiment of the present invention;

FIG. 2 is a view illustrating part of a magnetic head;

FIG. 3 is a view illustrating a state in which an alignment condition of magnetizations in a magnetic disc is detected;

FIG. 4 is a functional block diagram illustrating a function of detecting and recording an alignment condition;

FIG. 5 is a set of graphs representing examples of signals related to detection of an alignment condition;

FIG. 6 is a view illustrating an apparatus that detects alignment conditions during production of a magnetic disc;

FIG. 7 is a view representing parameters for computing an area that magnetically affects a point on a magnetic disc;

FIG. 8 is a graph representing the result of a computation of the coverage of an effect;

FIG. 9 is a functional block diagram illustrating an information recording function;

FIG. 10 is a graph representing an example of a signal that is sent to a magnetic head;

FIG. 11 is a set of flowcharts illustrating retry processing;

FIG. 12 is a schematic view illustrating a demagnetizing field;

FIG. 13 is a view illustrating an example of the effect of a demagnetizing field;

FIG. 14 is a view illustrating a storage medium in which magnetizations are in a non-alignment condition; and

FIG. 15 is a view illustrating a storage medium in which magnetizations are in an alignment condition.

### DETAILED DESCRIPTION OF THE INVENTION

An embodiment of the present invention will be explained below, with reference to the drawings.

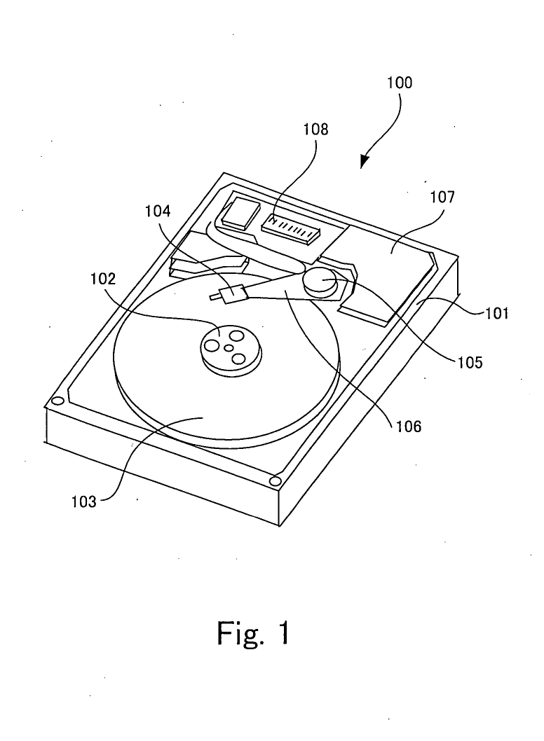

FIG. 1 is a view illustrating an information storage apparatus and a storage medium according to the embodiment of the present invention.

A hard disk device (HDD) 100 illustrated in FIG. 1 corresponds to the embodiment of an information storage apparatus according to the present invention and is utilized by being connected to or integrated in a higher-level apparatus typified by a personal computer.

A housing 101 of the HDD 100 illustrated in FIG. 1 includes a spindle motor 102, a magnetic disc 103 that is mounted on and pivotally driven by the spindle motor 102, and corresponds to an embodiment of a storage medium according to the present invention, a floating head slider 104 that faces the top side of the magnetic disc 103 in the vicinity thereof, an arm axle 105, a carriage arm 106 that horizontally moves above the magnetic disc 103, with respect to the arm axle 105, and on the front end of which the floating head slider 104 is fixed, a voice coil motor 107 that drives the carriage arm 106 to move horizontally, and a control circuit 108 that controls the operation of the HDD 100. The control circuit 108 corresponds to an example of an information recording section as termed in the present invention. The inner space of the housing 101 is closed by an unillustrated cover.

The HDD 100 implements recording of information in the magnetic disc 103 and reproducing of the information recorded in the magnetic disc 103. In recording and reproducing the information, in the first place, the carriage arm 106 is driven by the voice coil motor 107 including a magnetic circuit, whereupon the floating head slider 104 is positioned at a desired track on the rotating magnetic disc 103. A magnetic head unillustrated in FIG. 1 is mounted on the front end of the floating head slider 104.

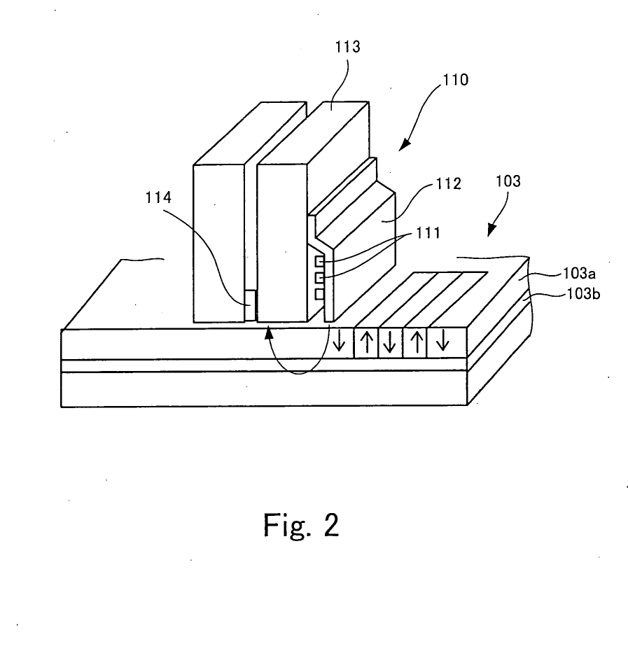

FIG. 2 is a view illustrating part of a magnetic head.

FIG. 2 is a view illustrating the partial cross-sectional structure of the magnetic head 110 mounted on the front end of the floating head slider 104 shown in FIG. 1. Due to rotation of the magnetic disc 103, the magnetic head 110 moves from the right-hand side to the left-hand side of FIG. 2, along the track of the magnetic disc 103.

A magnetic coil 111 is integrated in the magnetic head 110; when information is recorded, an electric recording signal is inputted to the magnetic coil 111, whereupon magnetic-field lines having a direction corresponding to the information are created through the magnetic coil 111. The magnetic-field lines concentrate in a main magnetic pole 112 and extend to the magnetic disc 103, whereby a magnetic field whose direction is perpendicular to the top side of the magnetic disc 103 is applied to a magnetic layer 103a; accordingly, magnetization having a direction corresponding to the information is formed at a position, in the magnetic layer 103a, opposing the main magnetic pole 112. The magnetic-field lines that form magnetization in the magnetic layer 103a return to a return yoke 113 of the magnetic head 110, after being diffused by a soft-magnetic underlayer (Soft Under Layer: SUL) 103b.

In the magnetic head 110, a reproducing element 114 is also integrated that indicates resistance corresponding to a magnetic field created through the magnetization; when the information is reproduced, an electric current is applied to the reproducing element 114, whereby a reproduction signal corresponding to the magnetization condition is created. In addition, in the present embodiment, the detailed type of the reproducing element 114 is not particularly specified; however, as the reproducing element 114, for example, a GMR (giant magnetoresistance) element, a TMR (tunnel magnetoresistance) element, or the like can be employed.

As described above, when, as a result of the magnetization formation through the magnetic head 110, an alignment condition of the magnetizations is created in the magnetic disc 103, the demagnetizing field due to the magnetizations in the alignment condition affects information recording and reproducing through the magnetic head 110; therefore, in the HDD according to the present embodiment, a function for detecting an alignment condition of magnetizations is integrated.

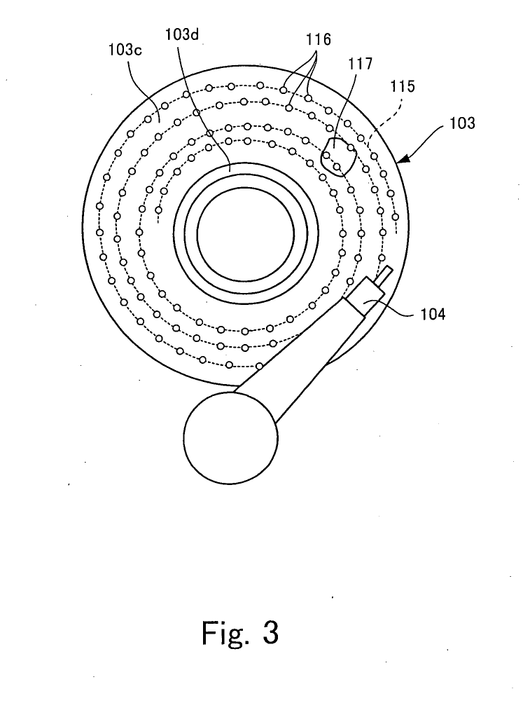

FIG. 3 is a view illustrating a state in which an alignment condition of magnetizations in a magnetic disc is detected.

In the magnetic disc 103, a recording region 103c in which information is recorded by the user and a management region 103d in which management information for managing the condition of the magnetic disc 103 and the like is recorded are provided; as a part of the management information, an alignment condition of magnetizations is also written in the management region 103d.

In the case where an alignment condition of magnetizations is detected, a magnetic head mounted on the front end of the head slider 104 moves from the inner-circumference side to the outer-circumference side of the magnetic disc 103, above the magnetic disc 103 and along a spiral 115 whose space between the spiral turns is wider than the space between the tracks. Then, at checkpoints 116 that exist along the spiral 115, respective alignment conditions of magnetizations are checked. In other words, the recording region 103c of the magnetic disc 103 is scanned in a two-dimensional fashion; when, an alignment region 117 exists in the magnetic disc 103, as described in detail below, it is detected that, at the check points 116 within the alignment region 117, magnetizations are in an alignment condition, and the alignment condition is recorded in the management region 103d.

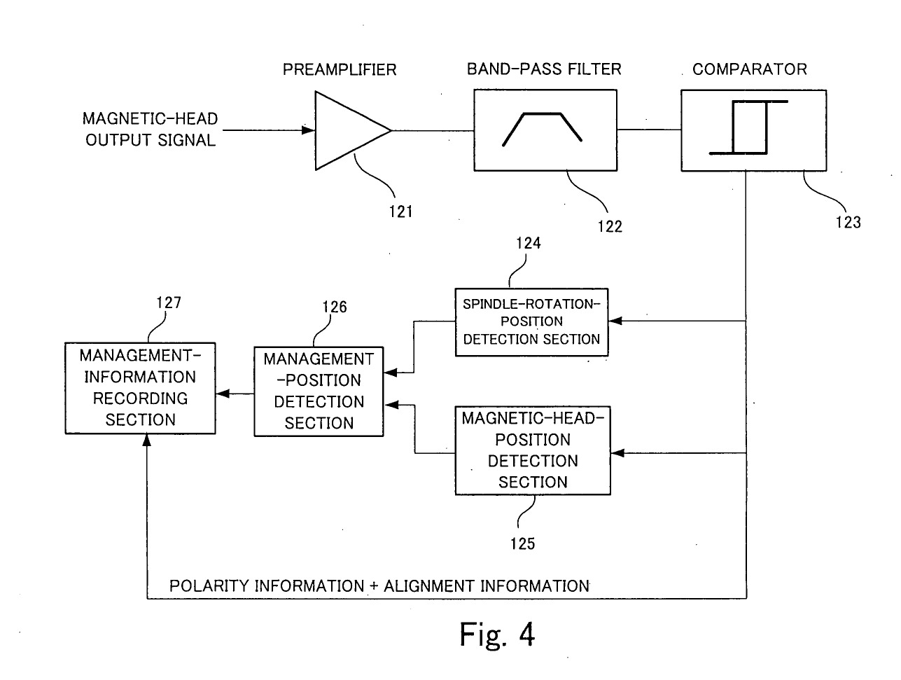

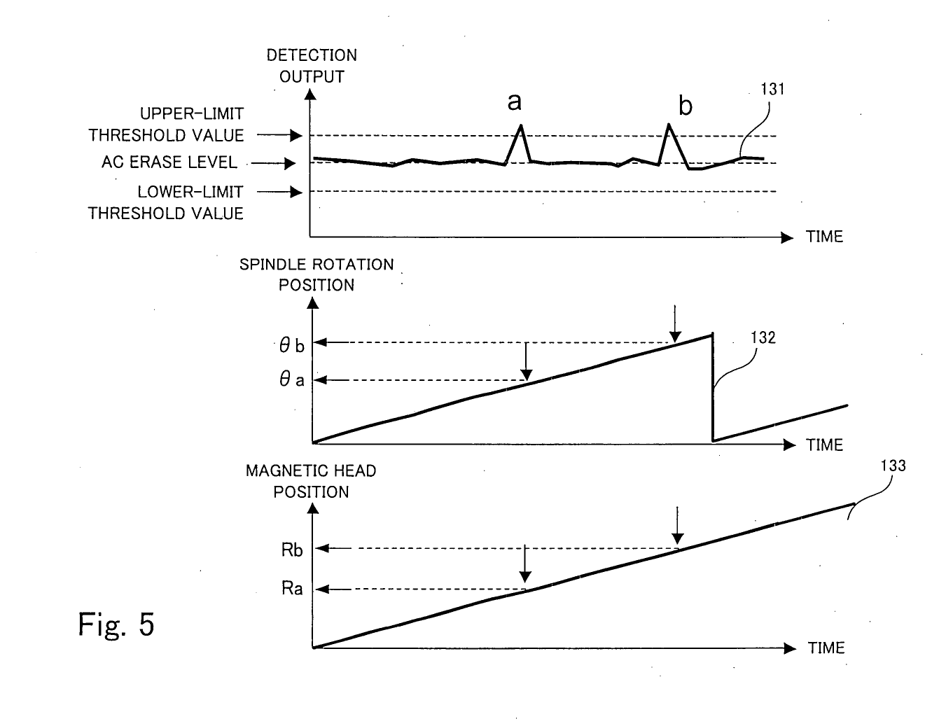

FIG. 4 is a functional block diagram illustrating a function of detecting and recording an alignment condition; FIG. 5 is a set of graphs representing examples of signals related to detection of an alignment condition.

Functional blocks illustrated in FIG. 4 represent respective functions integrated in the control circuit 108 illustrated in FIG. 1. In addition, it is not the subject of the present invention which function is implemented, in the control circuit 108, through which one of hardware and software; therefore, in the explanation for the present embodiment, without distinguishing hardware from software in particular, processing contents of each function and the like will be explained.

As explained with reference to FIG. 3, while the magnetic head scans the magnetic disc 103, the output signal from the magnetic head is inputted to and amplified by a preamplifier 121, and a band-pass filter 122 extracts necessary frequency components. As an example, in the case where the rotation speed of the magnetic disc is 5400 rpm and the moving speed of the magnetic head is 8 μm/turn, a band-pass filter is utilized that allows frequency components of 10 kHz to 1 MHz to pass.

A detection signal 131 as represented in the topmost graph in FIG. 5 is obtained from the band-pass filter 122 and inputted to a comparator 123 illustrated in FIG. 4. The detection signal 131 normally indicates output values in the vicinity of the AC erase level that corresponds to zero average magnetization; however, in an alignment region in which magnetizations are in an alignment condition, the detection signal 131 indicates an output value exceeding the upper-limit threshold value or below the lower-limit threshold value. It suggests that, when the output value is beyond the upper-limit threshold value, the magnetization is in an alignment condition having a specific polarity, and when the output value is below the lower-limit threshold value, the magnetization is in an alignment condition having a polarity opposite to the specific polarity. In the comparator 123, it is detected, with regards to the upper-limit threshold value and the lower-limit threshold value, whether or not the output value of the detection signal 131 exceeds either one of the threshold values; from the determination result, alignment information indicating that magnetizations are in an alignment condition and polarity information indicating the direction of the magnetizations in an alignment condition are obtained. In the example represented in FIG. 5, when two peaks a and b occur in the detection signal 131, respective alignment information items are created. The preamplifier 121, the band-pass filter 122, and the comparator 123 illustrated in FIG. 4 configure an example of a detection section as termed in the present invention.

The respective alignment information items obtained through the comparator 123 are inputted to a spindle-rotation-position detection section 124 and a magnetic-head-position detection section 125. In the spindle-rotation-position detection section 124, a rotation-position signal 132 as represented by the middle graph in FIG. 5 is monitored; in the magnetic-head-position detection section 125, a head-position signal 133 as represented by the bottommost graph in FIG. 5 is monitored. The rotation-position signal 132 is a saw-tooth signal that indicates an output value that is proportional to the rotation angle of the spindle motor and returns to output value zero each time the spindle motor rotates one turn; the head-position signal 133 indicates an output value proportional to the distance between the magnetic head and the center of the magnetic disc. Then, by the spindle-rotation-position detection section 124 and the magnetic-head-position detection section 125, the respective output values, of the rotation-position signal 132 and the head-position signal 133, at the timing when alignment information occurs are obtained. In the example in FIG. 5, at the timing when a first peak a in the detection signal 131 occurs, a first rotation-position output value θa and a first head-position output value Ra are obtained; at the timing when a second peak b in the detection signal 131 occurs, a second rotation-position output value θb and a second head-position output value Rb are obtained.

The respective output values, of the rotation-position signal 132 and the head-position signal 133, obtained as described above are inputted to a management-position detection section 126; in the management-position detection section 126, the check-point positions, on the magnetic disc, at which alignment conditions are specified based on the output values are specified. Specifically, what number sector in what number track is specified. The position specified as described above is inputted to a management-information recording section 127, along with the foregoing alignment information and the polarity information, and, as management information, is recorded by the management-information recording section 127 in the management region of the magnetic disc. Through the foregoing magnetic head, the management information is recorded. The management-information recording section 127 corresponds to an example of an alignment-condition recording section as termed in the present invention.

In addition, it can be readily inferred that the check points 116, among the check points 116 as illustrated in FIG. 3, that are positioned within the alignment region 117 and at which alignment conditions are detected are limited to part of the check points 116; therefore, in the present embodiment, the positions of the check points 116 at which alignment conditions are detected are recorded, but the positions of the other check points 116 at which no alignment conditions are detected are not recorded in particular.

The detection of alignment conditions according to the detection method explained above is implemented within the HDD, for example, when the power source for the HDD is initiated, when the accumulation of regions in which information items are rewritten after alignment conditions have been detected reaches 5% or more of the entire recording region, or when the detection of alignment conditions is instructed by the user. In this situation, it is desirable that, also during production of an HDD and/or a magnetic disc, alignment conditions be detected and, as initial values of management information, recorded in the management region; the detection during the production is implemented, for example, utilizing a dedicated apparatus for the detection.

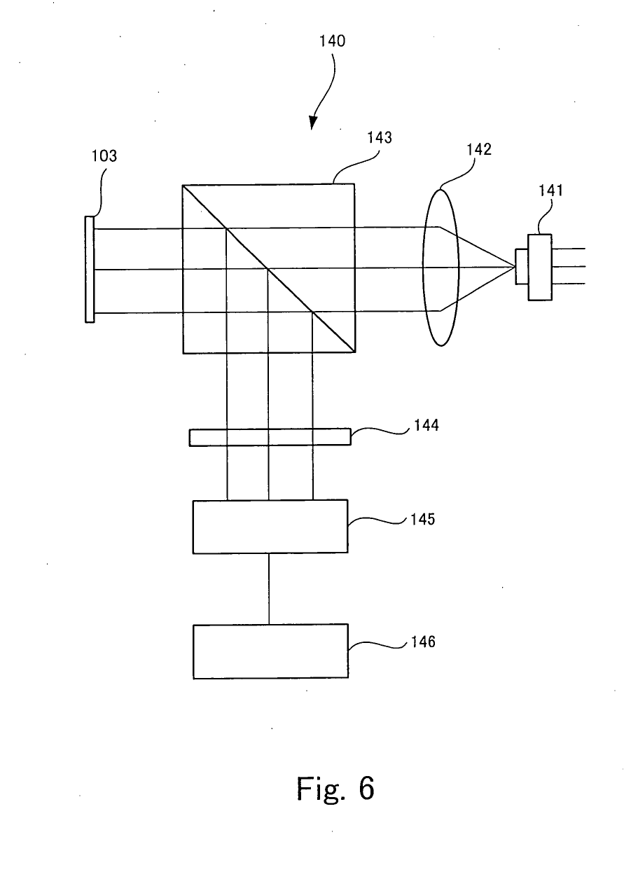

FIG. 6 is a view illustrating an apparatus that detects alignment conditions during production.

A detection apparatus 140 is constituted from a light source 141, a collimating lens 142, a polarization beam splitter 143, a light polarizer 144, a CCD 145, and an image processing apparatus 146.

The light source 141 emits diffusion light that is linearly polarized in a predetermined direction; the diffusion light emitted by the light source 141 is converted by the collimating lens 142 into parallel light. The parallel light enters the polarization beam splitter 143; due to the linear polarization in the predetermined direction, almost all of the parallel light rays are transmitted through the polarization beam splitter 143 and irradiated onto the magnetic disc 103. The magnetic disc 103 reflects the irradiated light; in this situation, based on the polar Kerr effect or the Kerr ellipse effect due to magnetization in the magnetic disc 103, the polarization condition of the light is changed into a polarization condition corresponding to the direction of magnetization. In consequence, the light rays that return from the magnetic disc 103 to the polarization beam splitter 143 include polarization components having directions different from the predetermined direction. Additionally, because the polarization components are reflected by the polarization beam splitter 143, the reflected light ray has two kinds of polarization conditions corresponding to the directions of magnetizations in the magnetic disc 103. The light polarizer 144 transmits the light ray that has one of the two kinds of polarization conditions more than the other; therefore, the strong-weak distribution of the rays that pass through the light polarizer 144 is read by the CCD 145, whereby the directions of magnetizations in the magnetic disc 103 can be read. Moreover, an image that represents the strong-weak distribution of the rays that has been read by the CCD 145 is processed in the image processing apparatus 146, whereby alignment regions are detected in which magnetizations in the magnetic disc 103 are in an alignment condition.

Meanwhile, as described above, the detection of an alignment condition of magnetizations is implemented at each of the checkpoints 116 as illustrated in FIG. 3; the checkpoints 116 are spaced wider than any one of the track pitch and the recording-mark pitch apart from one another. The appropriate spacing between the respective checkpoints 116 will be discussed below.

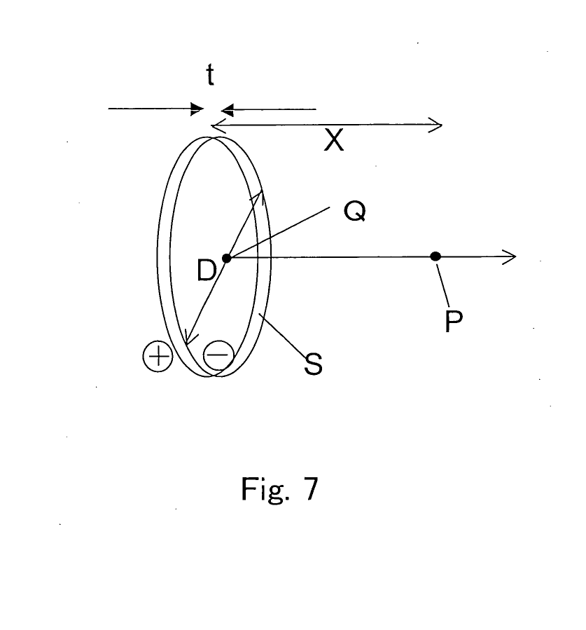

FIG. 7 is a view representing parameters for computing an area that magnetically affects a point on a magnetic disc.

With respect to a homogeneously magnetized magnetic layer, having a saturated magnetic flux density Bs, that is a thin circular disc of D in diameter, S in area, and t in thickness, as illustrated in FIG. 7, the magnetic-field intensity H at a point P that is on the center axis of the circular disc and spaced X apart from the circular disc is given by the following equation, by letting μ₀ denote the magnetic permeability in a vacuum:
H=(Bs·t·(D/2)ˆ2)/{(2·μ₀)·(Xˆ2+(D/2)ˆ2)ˆ0.5}

From the above equation, the intensity H of a magnetic field at a position Q where X is zero is given by the following equation, the magnetic field being created by an infinitely spread plate, formed of a magnetic layer of t in thickness, from which the circular disc is cut off:
H=Bs·t/(D·μ₀)

The H in the immediately above equation represents the magnetic effect, on the point Q, that is caused by a region that infinitely spreads outside the circular disc of diameter D and in which magnetizations are in an alignment condition; in other words, the H corresponds to the upper limit of the sum of the magnetic effects, on a point on the magnetic layer, that are caused by all the points spaced distance D or more apart from the point. As a result of specifically computing the magnetic effect, an appropriate space between the respective checkpoints can be obtained.

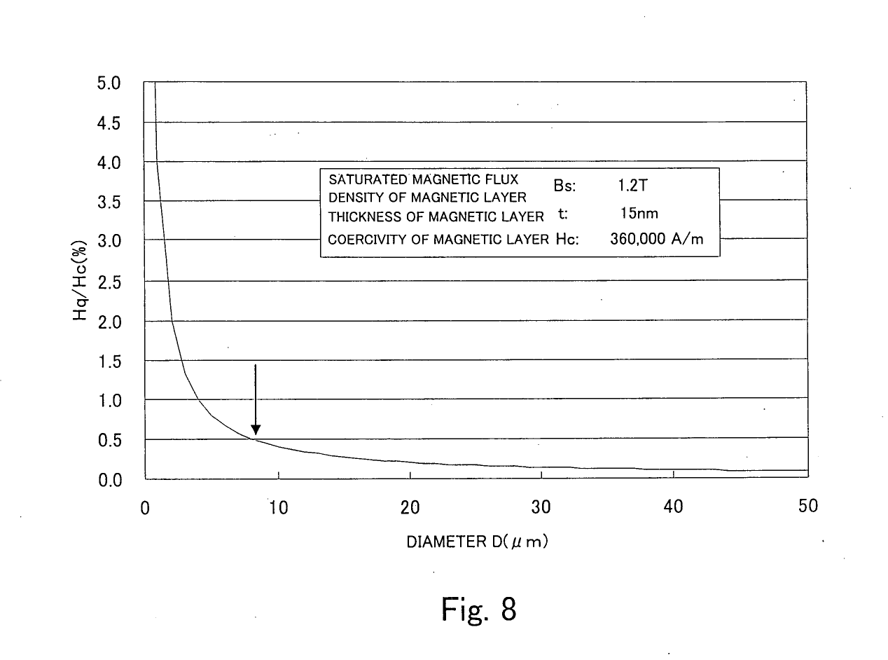

FIG. 8 is a graph representing the result of a specific computation of the magnetic effect.

The abscissa of the graph in FIG. 8 denotes the diameter D illustrated in FIG. 7; the ordinate denotes the ratio of the magnetic field Hq created at the position Q illustrated in FIG. 7 to the coercivity Hc of the magnetic layer. In addition, in FIG. 8, a computation result is represented that was obtained in the case where the saturated magnetic flux density Bs of the magnetic layer is 1.2 T, the thickness t of the magnetic layer is 15 nm, and the coercivity Hc of the magnetic layer is 360,000 A/m.

From the computation result represented in FIG. 8, it can be seen that, in the case where the diameter D is approximately 1 μm, the magnetic field Hq having intensity of approximately 5% of the coercivity Hc of the magnetic layer is created at the position Q, and in the case where, as indicated by an arrow in FIG. 8, the diameter D is elongated to approximately 8 μm, the magnetic field Hq created at the position Q is reduced to approximately 0.5% of the coercivity Hc.

Meanwhile, supposing that the specified variation in the coercivity Hc of the magnetic layer is ΔHc, and considering mass productivity of a storage medium, the ratio of ΔHc to Hc is approximately ±5%. In an actual apparatus, the ±5% variation in the coercivity is coped with, by adjusting the current that is applied to the magnetic head; if the effect of a demagnetizing field from the magnetic layer reaches approximately 10% of the variation, it is conceivable that some sort of countermeasure is required. In contrast, if the effect of a demagnetizing field is below 10% of the specified variation, it is conceivable that, even if the effect is neglected, no crucial malfunction is caused.

Additionally, the shorter the space between the respective check points is, the more accurately the effect of a demagnetizing field can be coped with; however, if the space between the respective check points is too short, management information is rendered massive. Because the coverage of the effect of the demagnetizing field due to a small-area alignment region is small, error-correction techniques that have traditionally been introduced into HDDs or the like can substantially eliminate the effect. Accordingly, it is important to detect an alignment region creating a demagnetizing field that has a wide-range and strong effect.

Taking comprehensively the foregoing circumstances into account, it is desirable to detect an alignment region having the diameter D that satisfies the following equation, i.e., to detect an alignment region having the diameter D of approximately 8 μm, in the case of the example represented in FIG. 8:
t·Bs/(μ₀·D·Hc)=ΔHc/(Hc·10)
Accordingly, the appropriate space between the respective checkpoints is approximately 8 μm; however, in the case where some margin exists in the capacity for management information, it is also desirable to employ a space, between the respective checkpoints, that is shorter than 8 μm.

The appropriate space between the respective checkpoints obtained as described above is not directly related to the track pitch of a magnetic disc. Therefore, in the case where the track pitch is the same on the entire magnetic disc, as well as in the case where track pitches at the inner and outer circumference sides are different from each other, i.e., in the case of a so-called variable-track-pitch magnetic disc, it is appropriate to detect an alignment condition, based on the space, between the respective check points, that is obtained as described above.

As explained below, the alignment condition detected as described above is referred to when information is recorded or when recording operation is retried, whereby appropriate recording or retrying recording is implemented.

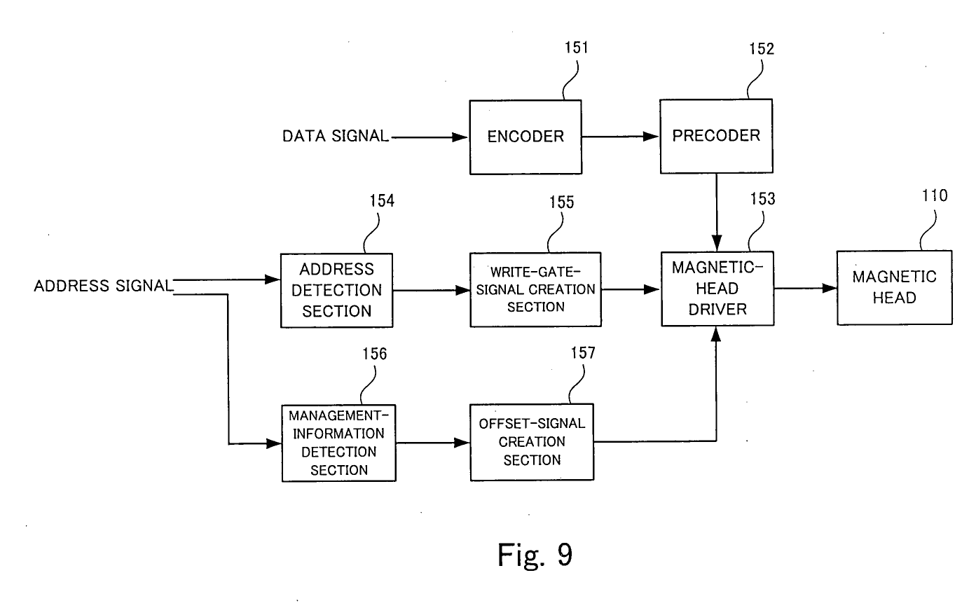

FIG. 9 is a functional block diagram illustrating an information recording function.

Functional blocks illustrated in FIG. 9 also represent respective functions integrated in the control circuit 108 illustrated in FIG. 1; also in the explanation here, without distinguishing hardware from software in particular, processing contents of each function and the like will be explained.

In the case where information is recorded in a magnetic disc, a higher-level apparatus typified by a personal computer or the like forwards to a HDD a data signal representing information to be recorded; in the control circuit 108 illustrated in FIG. 1, an address signal is created that represents the recording position for the information. After passing through an encoder 151 and a precoder 152, the data signal is turned into a writing signal representing the orientation of magnetization and inputted to a magnetic-head driver 153. An address signal is inputted to an address detection section 154; by, through the reproduction signal from the magnetic head 110 (shown in FIG. 2), detecting the same address as the address indicated by the address signal, the address detection section 154 detects that the magnetic head has reached the recording position and conveys the fact to a write-gate-signal creation section 155; then, in the write-gate-signal creation section 155, a write gate signal is created that instructs the magnetic-head driver 153 to start writing of the information. The address signal is inputted also to a management-information detection section 156, and it is determined whether or not an alignment condition has been detected at the check points close to (i.e., in the present embodiment, within a 8 μm radius of) the position corresponding to the address indicated by the address signal. The result of the determination by the management-information detection section 156 is inputted to an offset-signal creation section 157; when information is recorded in an alignment region, an offset signal that offsets a writing signal is created and inputted to the magnetic-head driver 153.

The magnetic-head driver 153 forwards to the magnetic head 110 composite signal consisting of the writing signal and the offset signal, at a timing instructed by the write gate signal, thereby making the magnetic head 110 implement writing in the magnetic disc. In addition, the composite signal is forwarded as a current signal.

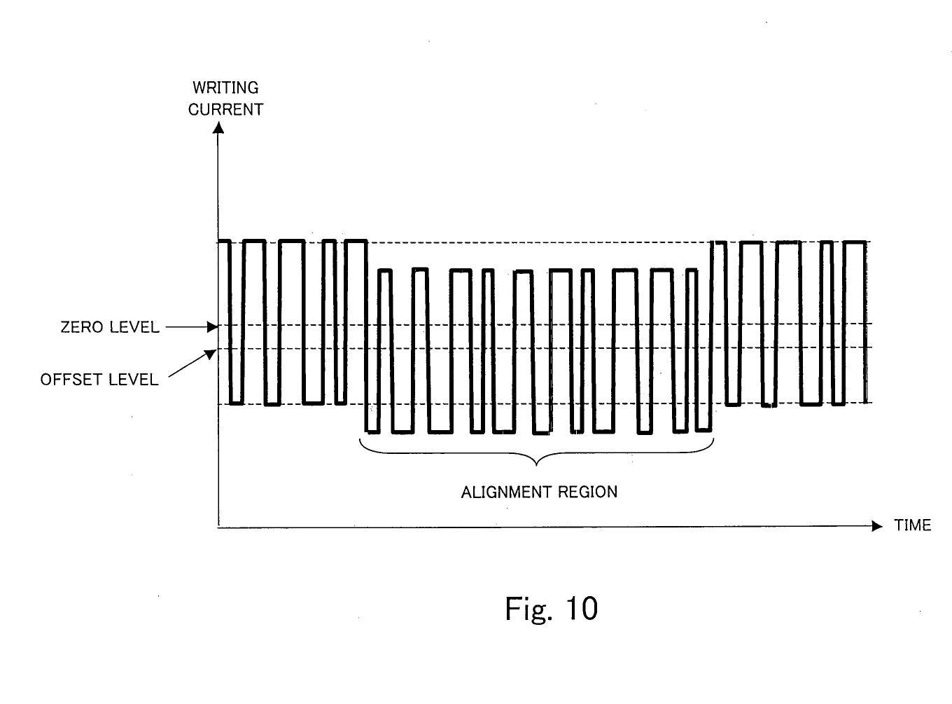

FIG. 10 is a graph representing an example of a signal that is sent to the magnetic head.

The abscissa of the graph in FIG. 10 denotes the time; the ordinate denotes the current value of a signal that is sent to the magnetic head.

The current value of the current signal that is forwarded to the magnetic head normally oscillates positively and negatively with respect to the zero level; however, in the case where the magnetic head is within an alignment region, the current signal indicates a current value that oscillates positively and negatively with respect to an offset level that is shifted in a direction corresponding to the direction of magnetizations in the alignment region. Through the offset described above, the effect of a demagnetizing field is cancelled out, whereby stable information recording is realized.

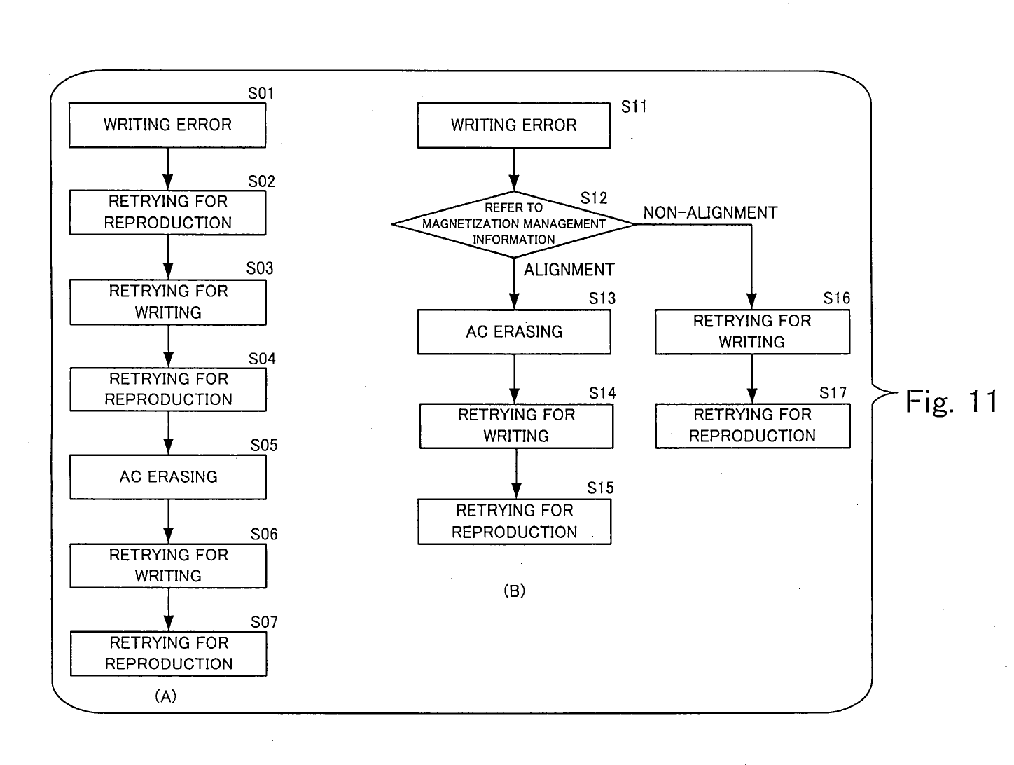

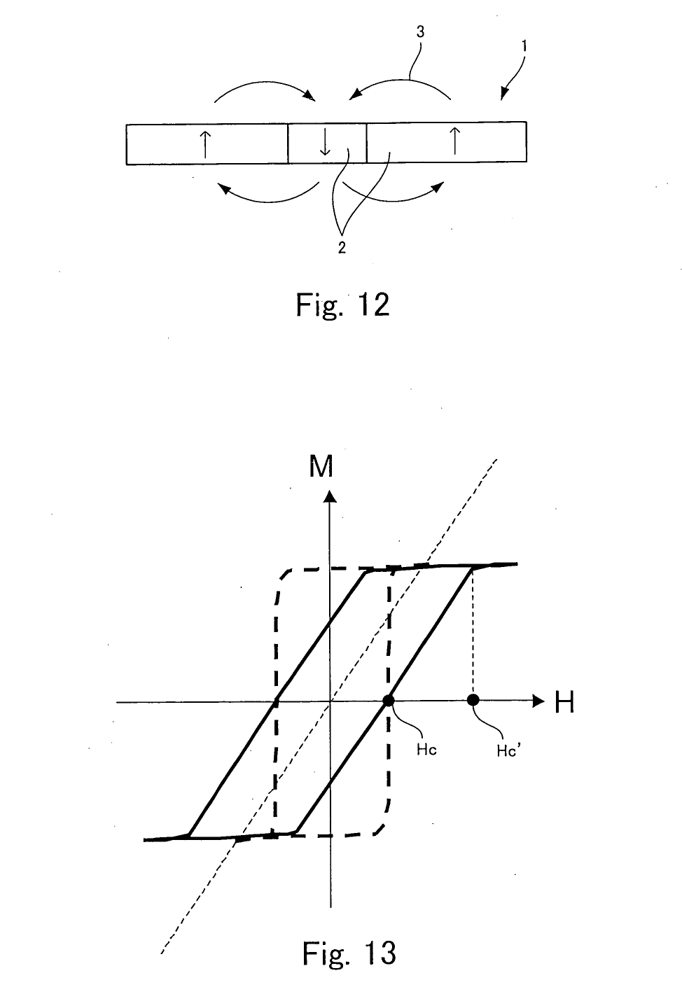

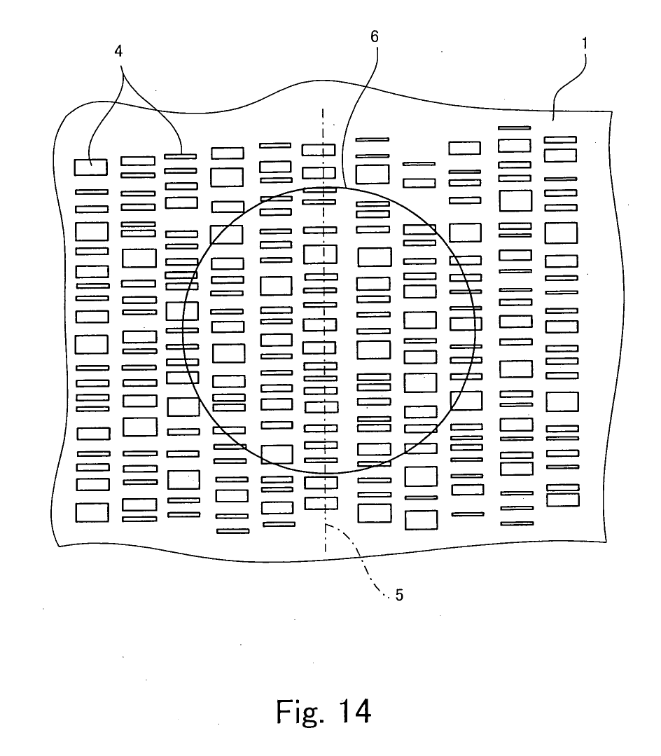

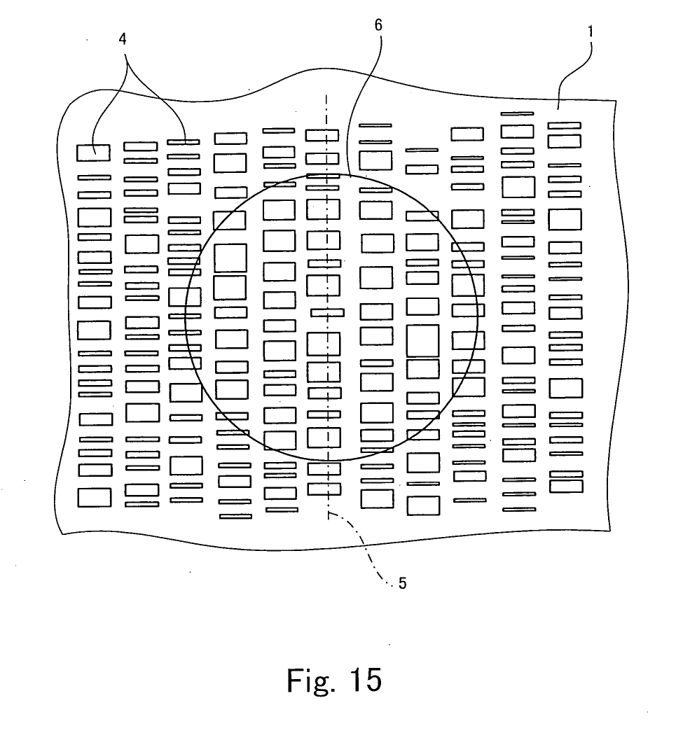

FIG. 11 is a set of flowcharts illustrating retry processing in the case where recording is retried (hereinafter referred to as “retry processing”).

FIG. 11 illustrates a flowchart (B) for retry processing according to the present embodiment and, for comparison, a flowchart (A) for conventional retry processing. In addition, in the flowcharts, while the flow in the case where retry halfway ends up with success is omitted, the flow in the case where retry is repeated all the way is illustrated. Additionally, in the present embodiment, the control circuit 108 illustrated in FIG. 1 controls the magnetic head or the like, thereby enabling the retry processing to be implemented.

In the conventional retry processing, when a writing error occurs (in the step S01), in the first place, retrying for reproduction is implemented (in the step S02), and the writing error is ascertained; then, retrying for writing (in the step S03) and retrying for reproduction (in the step S04) are implemented, and it is ascertained whether or not the rewriting has ended up with success. In the case where rewriting ends up with failure, the sum of magnetizations at the recording position is nullified through AC erasing (in the step S05), and, further, retrying for writing (in the step S06) and retrying for reproduction (in the step S07) are implemented.

In contrast, in the retry processing according to the present embodiment, when a writing error occurs (in the step S11), in the first place, management information is referred to, and it is determined whether or not the recording position is within an alignment region (in the step S12). In the case where the recording position is within an alignment region, the sum of magnetizations at the recording position is nullified through AC erasing (in the step S13), and, thereafter, retrying for writing (in the step S14) and retrying for reproduction (in the step S15) are implemented. In the case where the recording position is not within an alignment region, retrying for writing (in the step S16) and retrying for reproduction (in the step S17) are implemented without executing the AC erasing.

As described above, reference to management information can do away with unnecessary retrying operation, thereby speeding up the retry processing.

In addition, as a conventional retry processing, instead of the processing illustrated in FIG. 11, another processing is conceivable in which, immediately after writing error is ascertained, the step S05 and the following steps are implemented; however, in such a processing, originally unnecessary AC erasing is implemented each time writing error occurs, whereby electric power is wastefully dissipated. In contrast, in the retry processing according to the present embodiment, the unnecessary AC erasing described above is avoided.

As described heretofore, in the present embodiment, an alignment condition of magnetizations is referred to when information is recorded or when recording is retried, whereby appropriate recording or retrying in accordance with the alignment condition is implemented.

What is claimed is:

1. An information storage apparatus that stores information in a storage medium, through the perpendicular magnetic recording system, the information storage apparatus comprising:
a detection section that detects an alignment condition of magnetizations at each of portions on the storage medium; and
an alignment-condition recording section that records in the storage medium the alignment condition that has been detected by the detection section.

2. The information storage apparatus according to claim 1, further comprising an information recording section that records information in the storage medium, in a manner in accordance with the alignment condition.

3. The information storage apparatus according to claim 1, further comprising an information recording section that records information in the storage medium and, in the case where recording ends up with failure, records the information again, in a manner in accordance with the alignment condition.

4. The information storage apparatus according to claim 1, wherein the detection section detects an alignment condition of magnetization at each of representative points on the storage medium, and the magnetic effect on each representative point, from a far portion on the storage medium that is away from the representative point further than the other representative points, is 10% of or less than the magnetic effect from a vicinal portion on the storage medium excluding the far portion.

5. The information storage apparatus according to claim 1, wherein a magnetic head is included that records and reproduces information in the storage medium, and the detection section detects an alignment condition at each position, by, through the magnetic head, scanning the storage medium, in a two-dimensional fashion.

6. A storage medium in which, through the perpendicular magnetic recording system, information is stored, the storage medium comprising:
an information storage region in which the information is stored; and
an alignment-condition storage section in which an alignment condition of magnetizations at each of portions in the information storage region is stored.
